(19) United States
(12) Patent Application Publication
(10) Pub. No.: US 2008/0059996 A1
(43) Pub. Date: Mar. 6, 2008

(54) Hierarchical based advertising system and broadcasting method thereof

(75) Inventors: Houng-Jyh Wang, Taipei City (TW); Eugene Yu, Sangchong City (TW); Liang-Chao Tu, Nanjhou Township (TW); Yung-Tzu Huang, Toucheng Township (TW); Yoshiyuki Shimizu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Teco Electric & Machinery Co., Ltd.

(21) Appl. No.: 11/881,563

(22) Filed: Jul. 27, 2007

(30) Foreign Application Priority Data
Sep. 1, 2006 (TW) 95132484

(51) Int. Cl. H04N 7/10

(52) U.S. Cl. 725/32

(57) ABSTRACT

A hierarchical based advertising system including a primary server, at least one secondary server and at least one terminal is provided. The primary server has advertisement data. The secondary server is coupled with the primary server while the terminal is coupled with the secondary server. The primary server, the secondary server and the terminal are arranged in a hierarchical structure. The primary server transmits the advertisement data to the secondary server to update advertisements displayed on the terminal. A broadcasting method of the hierarchical based advertising system is also provided.

### RELATED APPLICATIONS

This application claims priority to Taiwan Application Serial Number 95132484, filed Sep. 1, 2006, which is herein incorporated by reference.

### BACKGROUND

1. Field of Invention

The present invention relates to an advertising system and broadcasting method thereof, and more particularly, to a hierarchical based advertising system and broadcasting method thereof.

2. Description of Related Art

Advertising systems for broadcasting commercials are commonly seen in public places such as transit stations and shopping malls. Generally, a conventional advertising system includes a server to store advertisement data and several client ends to display advertisements. In practice, upon the requests sent by the client ends, the server transmits the advertisements to the client ends by video streaming and peer-to-peer technology. Then, the advertisements are broadcast on the client end.

With the rapid development of information technology, advertisements can be distributed to the client end through a network. However, the conventional advertising system has several problems. First, the maintenance requirements of each server increase the cost of maintaining the system, particularly when the distance between the servers is far. Second, because that the advertisement data on the client end cannot be updated until the client end sends a request and the server cannot respectively control the advertisement data on the client ends and the broadcast method thereof, the commercials displayed on the client ends cannot be refreshed instantaneously although the advertisement data in the server is updated. Third, the broadcast of the commercials may break down due to server malfunctions. Accordingly, it is required to provide an advertising system and broadcasting method thereof to solve the problems mentioned above.

### SUMMARY

In an aspect of the present invention, a hierarchical based advertising system and broadcasting method thereof are provided. The server and the terminals of the system are arranged hierarchically. Advertisement data of the system can be updated hierarchically, so as to decrease the cost of maintaining the system.

In another aspect of the present invention, a hierarchical based advertising system and broadcasting method thereof are provided. Advertisement data of the system can be updated by the server, so as to update the advertisements of the terminals instantaneously.

In yet another aspect of the present invention, a hierarchical based advertising system and broadcasting method thereof are provided. The system is capable of broadcasting advertisements even if the server malfunctions, so as to decrease the downtime of the system.

In accordance with an embodiment of the present invention disclosed herein, a hierarchical based advertising system including a primary server, at least one secondary server and at least one terminal is provided. The primary server has advertisement data. The secondary server is coupled with the primary server while the terminal is coupled with the secondary server. The primary server, the secondary server and the terminal are arranged in a hierarchical structure. The primary server transmits the advertisement data to the secondary server to update advertisements displayed on the terminal.

In accordance with an embodiment of the present invention disclosed herein, a broadcasting method of a hierarchical based advertising system is provided. A primary server is coupled with at least one secondary server and at least one terminal is coupled with the secondary server, whereby the primary server, the secondary server and the terminal are arranged in a hierarchical structure. Then, advertisement data for the terminal is generated. The primary server transmits the advertisement data to the secondary server. Then, the secondary server processes the advertisement data to generate a raw data stream. Subsequently, the raw data stream is transmitted to the terminal.

In accordance with an embodiment of the present invention disclosed herein, a broadcasting method of a hierarchical based advertising system is provided. A primary server is coupled with at least one secondary server and at least one terminal is coupled with the secondary server, whereby the primary server, the secondary server and the terminal are arranged in a hierarchical structure. Then, advertisement data for the terminal is generated. The primary server transmits the advertisement data to the secondary server. Subsequently, the terminal processes the advertisement data to show commercials.

In accordance with an embodiment of the present invention disclosed herein, the server and the terminals of the system are arranged hierarchically. The advertisements of the advertising system can be pushed by the server and promptly updated in the terminals hierarchically, thus decreasing the cost of maintaining the system. Moreover, the advertising system can broadcast the advertisements even if the server malfunctions, so as to decrease the downtime of the system.

It is to be understood that both the foregoing general description and the following detailed description are by examples and are intended to provide further explanations of the invention as claimed.

### BRIEF DESCRIPTION OF THE DRAWINGS

These and other features, aspects and advantages of the invention will become apparent by reference to the following description and accompanying drawings, which are given by way of illustration only, and thus are not limitative of the invention, wherein:

FIG. 1 is a block diagram of the hierarchical based advertising system according to one preferred embodiment of the present invention;

FIG. 2 is an illustration showing the primary server update the advertisement data;

FIG. 3 is an illustration showing a terminal, in accordance with an embodiment of the present invention; and

FIG. 4 is a flowchart showing the broadcasting method of the hierarchical based advertising system, in accordance with an embodiment of the present invention.

### DESCRIPTION OF THE PREFERRED EMBODIMENTS

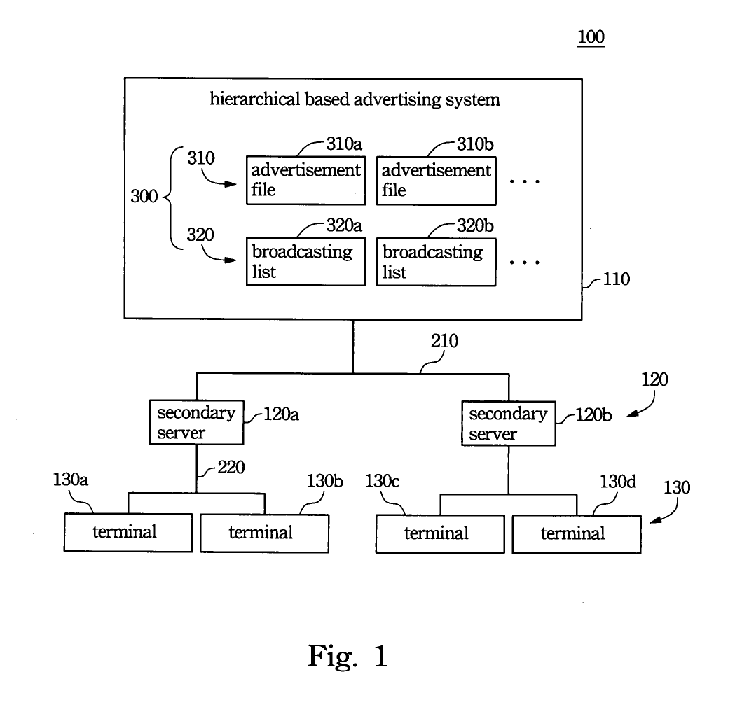

FIG. 1 is a block diagram of the hierarchical based advertising system according to one preferred embodiment of the present invention. Referring to FIG. 1, the hierarchical based advertising system 100 includes a primary server 110, a plurality of secondary servers 120 and a plurality of terminals 130. The primary server 110 is located on the first level of the hierarchical based advertising system 100. The secondary servers 120, are located on the second level of the hierarchical based advertising system 100 and are coupled with the primary server 110 via the first network 210. The terminals 130 are located on 10 the third level of the hierarchical based advertising system 100 and are coupled with the secondary servers 120 via the second network 220. The first network 210 and the second network 220 can be implemented on a Local Area Network (LAN) and/or Wide Area Network (WAN), over wire and/or wireless networks, by using encrypted and/or non-encrypted technology. However, anyone who is skilled in the technology of the present embodiment will understand that the technology of the present embodiment is not limited thereto. For example, the secondary servers 120 on the second level can further be divided into several levels. In addition, the primary server 110, the secondary servers 120 and the terminals 130 can be connected via only one network such as the first network 210 or the second network 220.

More specifically, the primary server 110, which can be a control center of the hierarchical based advertising system 100, has the advertisement data 300 for the terminals 130. The advertisement data 300 includes advertisement files 310 and broadcasting lists 320. For example, the primary server 110 stores the advertisement file 310a and the broadcasting list 320a for the terminal 130a. The primary server also stores the advertisement file 310b and the broadcasting list 320b for the terminal 130b. Of course, the terminal 130a and the terminal 130b can have the identical advertisement file and broadcasting list. The secondary servers 120 can be distant from the primary server 110 to manage adjacent terminals. For example, the terminal 130a adjacent to the terminal 130b are both connected with the secondary server 120a, while the terminal 130c adjacent to the terminal 130d are both connected with the secondary server 120b. The advertisement files 310 and the broadcasting lists 320 may vary according to the location of the terminals 130. The primary server 110 can update the secondary servers 120 and the terminals 130 on the advertisement data. In other words, the latest advertisement files 310 and the latest broadcasting lists 320 can be pushed to the terminals 130 via the secondary servers 120, thus updating the terminals promptly.

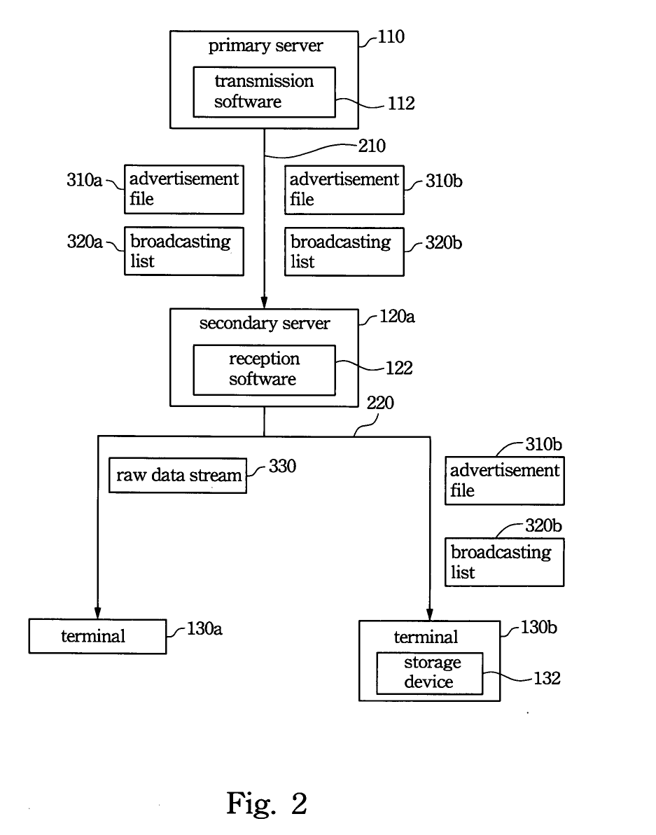

FIG. 2 is an illustration showing the primary server update the advertisement data. Referring to FIG. 2, the terminal 130a may be a media board or a set top box. The secondary server 120a executes reception software 122 such as FTP (File Transfer Protocol) server software, while the primary server 110 executes transmission software 112 such as FTP client software. Thus, the primary server 110 can upload the advertisement file 310a and the broadcasting list 320a to the secondary server 120a. Also, the primary server 110 can transmit the advertisement file 310a and the broadcasting list 320a to the secondary server 120a using the file sharing function of the Microsoft operating system. After the broadcasting list 320a and the advertisement file 310a are transmitted from the primary server 110 to the secondary server 120a, the secondary server 120a can broadcast the advertisement file 310a according to the broadcasting list 320a so as to output a raw data stream 330 to the terminal 130a, thus updating the advertisement shown thereon. Of course, updating the advertisement file 310a and the broadcasting list 320a can be initiated by the terminal 130a or by the secondary server 120a by sending a request to the primary server 110.

With continued reference to FIG. 2, compared to the terminal 130a, the terminal 130b has a storage device 132 disposed thereon to store the advertisement file 310b and the broadcasting list 320b. In addition, the terminal 130b is capable of broadcasting the advertisement file 310b according to the broadcasting list 320b. For example, the advertisement file 310b and the broadcasting list 320b corresponding to the terminal 130b can be transmitted from the primary server 110 to the secondary server 120a, and then to the terminal 130b. The terminal 130b can store the advertisement file 310b as well as the broadcasting list 320b in the storage device 132. Hence, the terminal 130b can broadcast the advertisement file 310b stored in the storage device 132 when the update cannot be done due to the malfunction of the servers or the networks, thus decreasing the downtime of the system.

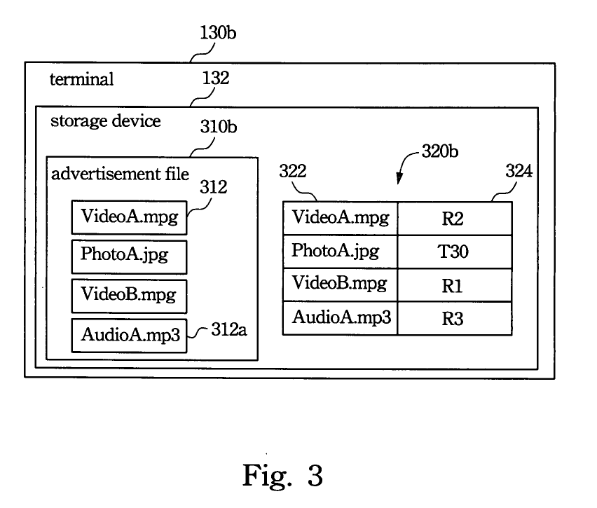

FIG. 3 is an illustration showing a terminal, in accordance with an embodiment of the present invention. Referring to FIG. 2 and FIG. 3, for example, the terminal 130b can download and save the advertisement file 310b and the broadcasting list 320b in the storage device 132. The terminal 130b can also broadcast the advertisement file 310b according to the broadcasting list 320b. More specifically, the advertisement file 310b includes a plurality of AV (AudioNideo) files 312. The broadcasting list 320b, which may be a text file, includes the corresponding file names 322 and the broadcasting parameters 324 of the AV files 312. The broadcasting parameter 324 provides the number of times or the duration of the corresponding AV file 312 broadcasts. For example, the parameter R2 represents that the corresponding AV files would be shown two times, while the parameter T30 represents that the corresponding AV file would be shown thirty seconds. Referring to FIG. 3, the file name of the AV file 312a is “AudioA.mp3” and the broadcasting parameter “R3” represents that the AV file 312a will be shown at the terminal 130b for three times.

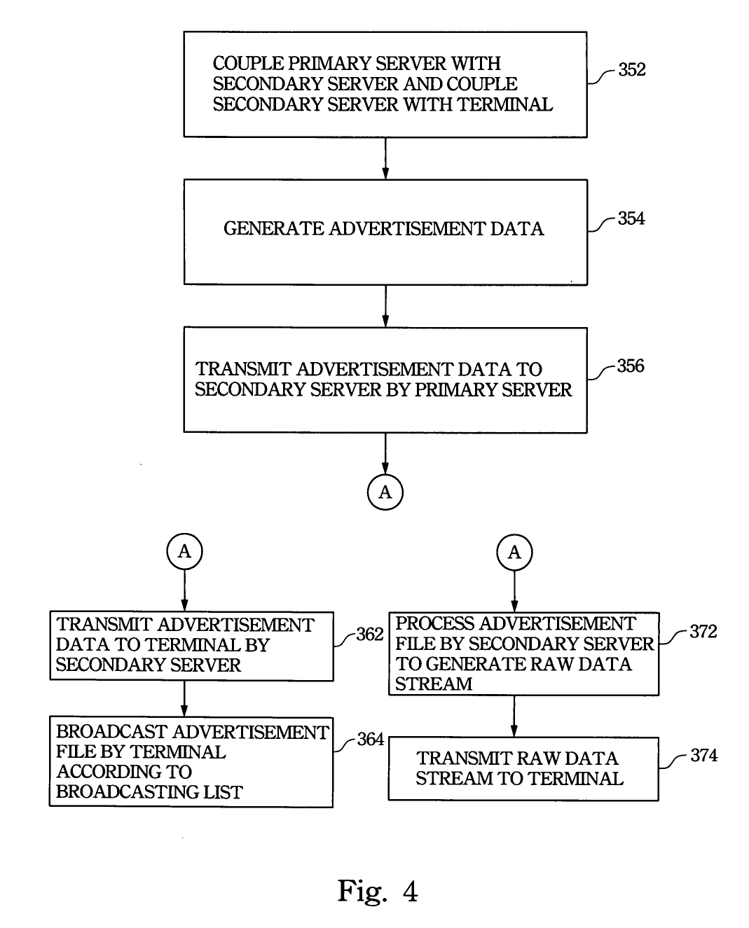

FIG. 4 is a flowchart showing the broadcasting method of the hierarchical based advertising system, in accordance with an embodiment of the present invention. The method starts in step 352 by coupling a primary server with at least one secondary server and coupling the secondary server with at least one terminal, wherein the primary server, the secondary server and the terminal are arranged in a hierarchical structure. For example, in FIG. 1, by utilizing the first network and the second network, the secondary servers can be coupled with the primary server, while the terminals can be coupled with the secondary servers. In step 354, advertisement data of the terminals is generated. In step 356, the advertisement data is transmitted to the secondary server by the primary server, so as to push the advertisement data and broadcast advertisements from the secondary servers to the terminals.

It is worth noting that the broadcasting method can be modified according to the type of the terminal. For example, when the terminal has the storage device and is capable of processing the advertisement data. In step 362, a secondary server transmits the advertisement file and the broadcasting list to the terminal to update the advertisement hierarchically. Then, in step 364, the terminal broadcasts the advertisement file according to the broadcasting list. In other words, the terminal processes the advertisement data to show commercials. Alternatively, if the terminals can only accept the raw data stream, in step 372, the advertisement file is processed by the secondary server to generate a raw data stream. Subsequently, in step 374, the raw data stream is transmitted to the terminals to show commercials thereon.

In accordance with an embodiment of the present invention disclosed herein, the server and the terminals of the system are arranged hierarchically. The advertisements of the advertising system can be pushed by the server and promptly updated in the terminals hierarchically, thus decreasing the cost of maintaining the system. Moreover, the advertising system can broadcast the advertisements even if the server malfunctions, so as to decrease the downtime of the system.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A hierarchical based advertising system, comprising:
a primary server, having advertisement data;
at least one secondary server, coupled with the primary server; and
at least one terminal, coupled with the secondary server;
wherein the primary server, the secondary server and the terminal are arranged in a hierarchical structure, and wherein the primary server transmits the advertisement data to the secondary server to update advertisements displayed on the terminal.

2. A hierarchical based advertising system as recited in claim 1, wherein the advertisement data comprises an advertisement file and a broadcasting list.

3. A hierarchical based advertising system as recited in claim 2, wherein the broadcasting list comprises at least one file name and at least one broadcasting parameter.

4. A hierarchical based advertising system as recited in claim 1, wherein the secondary server is coupled with the primary server via a first network, and wherein the terminal is coupled with the secondary server via a second network.

5. A hierarchical based advertising system as recited in claim 4, wherein the first network is implemented on a wide area network.

6. A hierarchical based advertising system as recited in claim 4, wherein the first network is implemented on a local area network.

7. A hierarchical based advertising system as recited in claim 1, wherein the terminal has a storage device disposed thereon to store the advertisement data.

8. A broadcasting method of a hierarchical based advertising system, comprising:
coupling a primary server with at least one secondary server and coupling at least one terminal with the secondary server, whereby the primary server, the secondary server and the terminal are arranged in a hierarchical structure;
generating advertisement data for the terminal;
utilizing the primary server to transmit the advertisement data to the secondary server;
utilizing the secondary server to process the advertisement data to generate a raw data stream; and
transmitting the raw data stream to the terminal.

9. A broadcasting method of a hierarchical based advertising system as recited in claim 8, wherein the step of coupling comprises coupling the primary server with the secondary server via a first network and coupling the terminal with the secondary server via a second network.

10. A broadcasting method of a hierarchical based advertising system as recited in claim 9, wherein the first network is implemented on a wide area network.

11. A broadcasting method of a hierarchical based advertising system as recited in claim 9, wherein the first network is implemented on a local area network.

12. A broadcasting method of a hierarchical based advertising system as recited in claim 8, wherein the step of generating comprises generating the advertisement data according to the location of the terminal.

13. A broadcasting method of a hierarchical based advertising system as recited in claim 8, wherein the step of generating comprises generating an advertisement file and a broadcasting list.

14. A broadcasting method of a hierarchical based advertising system as recited in claim 13, wherein the broadcasting list includes at least one file name and at least one broadcasting parameter.

15. A broadcasting method of a hierarchical based advertising system, comprising:
coupling a primary server with at least one secondary server and coupling at least one terminal with the secondary server, whereby the primary server, the secondary server and the terminal are arranged in a hierarchical structure;
generating advertisement data for the terminal;
utilizing the primary server to transmit the advertisement data to the secondary server;
utilizing the secondary server to transmit the advertisement data to the terminal;
utilizing the terminal to process the advertisement data to show commercials.

16. A broadcasting method of a hierarchical based advertising system as recited in claim 15, wherein the step of coupling comprises coupling the primary server with the secondary server via a first network and coupling the terminal with the secondary server via a second network.

17. A broadcasting method of a hierarchical based advertising system as recited in claim 15, wherein the step of generating comprises generating the advertisement data according to the location of the terminal.

18. A broadcasting method of a hierarchical based advertising system as recited in claim 15, wherein the step of generating comprises generating an advertisement file and a broadcasting list.

19. A broadcasting method of a hierarchical based advertising system as recited in claim 18, wherein the broadcasting list includes at least one file name and at least one broadcasting parameter.

20. A broadcasting method of a hierarchical based advertising system as recited in claim 15, further comprising a step to store the advertisement data in a storage device of the terminal after the step of utilizing the secondary server to transmit the advertisement data to the terminal.
